(19) United States
(12) Patent Application Publication
(10) Pub. No.: US 2011/0295629 A1
(43) Pub. Date: Dec. 1, 2011

(54) MONITORING SYSTEM, MONITORING METHOD, AND COMPUTER READABLE MEDIUM

(75) Inventor: Tatsuomi KITA, Kanagawa (JP)

(73) Assignee: FUJI XEROX CO., LTD., Tokyo (JP)

(21) Appl. No.: 12/966,441

(22) Filed: Dec. 13, 2010

(30) Foreign Application Priority Data
May 31, 2010 (JP) 2010-124588

(51) Int. Cl. G06Q 10/00

(52) U.S. Cl. 705/7.11

(57) ABSTRACT

A monitoring system includes a communication information acquisition unit, an information acquisition unit, a condition information acquisition unit, a determination unit, and a determination information output unit. The communication information acquisition unit acquires communication information contained in each piece of electronic document data and containing identification information about a project and time information corresponding to acquisition time of each piece of electronic document data as target communication information. The information acquisition unit acquires progress information concerning a progress situation about the project based on the target communication information. The condition information acquisition unit acquires condition information relevant to the acquired progress information. The determination unit determines whether or not information corresponding to the target communication information matches a condition indicated by the condition information. The determination information output unit outputs determination information based on the determination result of the determination unit.

### CROSS-REFERENCE TO RELATED APPLICATIONS

This application is based upon and claims priority under 35 USC 119 from Japanese Patent Application No. 2010-124588, filed May 31, 2010.

### BACKGROUND

### Technical Field

This invention relates to a monitoring system, a monitoring method, and a computer readable medium.

### SUMMARY OF THE INVENTION

According to an aspect of the invention, a monitoring system includes a communication information acquisition unit, an information acquisition unit, a condition information acquisition unit, a determination unit, and a determination information output unit. The communication information acquisition unit acquires communication information contained in each piece of electronic document data and containing identification information about a project and time information corresponding to acquisition time of each piece of electronic document data as target communication information. The information acquisition unit acquires progress information concerning a progress situation about the project based on the target communication information. The condition information acquisition unit acquires condition information relevant to the acquired progress information. The determination unit determines whether or not information corresponding to the target communication information matches a condition indicated by the condition information. The determination information output unit outputs determination information based on the determination result of the determination unit.

### BRIEF DESCRIPTION OF THE DRAWINGS

Exemplary embodiments of the invention will be described in detail based on the following figures, wherein:

FIG. 1 is a drawing to describe a monitoring system in a first exemplary embodiment of the invention;

FIG. 2 is a drawing to describe the configuration of a terminal, a monitoring server in the first exemplary embodiment of the invention;

FIG. 3 is a drawing to functionally describe the configuration of the monitoring server in the first exemplary embodiment of the invention;

FIG. 4 is a drawing to describe communication information in the first exemplary embodiment of the invention;

FIG. 5 is a drawing to describe electronic document data in the first exemplary embodiment of the invention;

FIG. 6 is a drawing to describe management information in the first exemplary embodiment of the invention;

FIG. 7 is a drawing to show an output example of warning information in the first exemplary embodiment of the invention;

FIG. 8 is a drawing to describe a flow of the monitoring system in the first exemplary embodiment of the invention;

FIG. 9 is a drawing to functionally describe the configuration of a monitoring server in a second exemplary embodiment of the invention;

FIG. 10 is a drawing to functionally describe the configuration of a statistical value acquisition section shown in FIG. 9;

FIG. 11 is a drawing to show an example to describe processing in a second exemplary embodiment;

FIG. 12 is a drawing to describe a flow of a monitoring system in the second exemplary embodiment of the invention;

FIG. 13 is a drawing to functionally describe the configuration of a statistical value acquisition section in a third exemplary embodiment of the invention;

FIG. 14 is a drawing to show an example to describe processing in the third exemplary embodiment;

FIG. 15 is a drawing to describe a flow of a monitoring system in the third exemplary embodiment of the invention;

FIG. 16 is a drawing to functionally describe the configuration of a monitoring server in a fourth exemplary embodiment of the invention;

FIG. 17 is a drawing to describe a flow of a monitoring system in the fourth exemplary embodiment of the invention;

FIG. 18 is a drawing to functionally describe the configuration of a monitoring server in a fifth exemplary embodiment of the invention;

FIG. 19 is a drawing to describe the storage format of official position information and name information;

FIG. 20 is a drawing to describe a flow of a monitoring system in the fifth exemplary embodiment of the invention;

FIG. 21 is a drawing to functionally describe the configuration of a monitoring server in a sixth exemplary embodiment of the invention; and

FIG. 22 is a drawing to describe a flow of a monitoring system in the sixth exemplary embodiment of the invention.

### DETAILED DESCRIPTION

Exemplary embodiments of the invention will be discussed with reference to the accompanying drawings. In the drawings, identical or similar elements are denoted by the same reference numerals and will not be discussed again.

### First Exemplary Embodiment

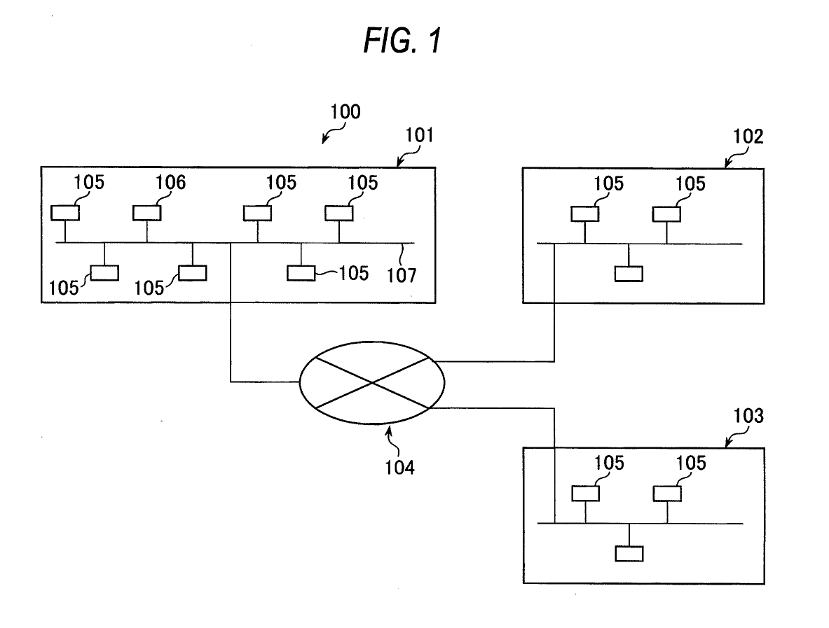

FIG. 1 is a drawing to describe a monitoring system in a first exemplary embodiment of the invention. As shown in FIG. 1, a monitoring system 100 in the exemplary embodiment is formed in one local area network (LAN) 101 of LANs 101 to 103 managed by independent organizations (for example, enterprises, departments in an enterprise, etc.,), for example. As shown in FIG. 1, the LANs 101 to 103 are connected by a communication network 104 (for example, the Internet). In FIG. 1, the number of LANs is three, but any number of LANs may be installed.

Terminals 105 used by the users belonging to the organization are connected through a network 107 in each of the LANs 101 to 103. The terminal 105 is a copier, a FAX machine, a multiple function device having a FAX function, a copy function, a function of scanning data and transmitting the data to any other terminal 105, etc., a personal computer, a mail server, a database, etc. A fire wall (not shown), etc., for preventing entry to the inside from the outside of each of the LANs 101 to 103 is installed in each of the LANs 101 to 103. The LAN 101 includes a monitoring server 106 for monitoring and analyzing a job flow described later.

The embodiment will be discussed by assuming the case where a company having the LAN 101 is a consignor of one project, a company having the LAN 102 or a company having the LAN 103 is a consignee of the one project, and the monitoring server 106 monitors the progress situation of the project, but the embodiment is not limited to the case. For example, LAN may be installed between departments in a company and a project between the departments may be monitored, etc.

The project is an activity for accomplishing an object in a given time period and is made up of one or more steps and information concerning the project is managed using the system in FIG. 1 and is processed as required.

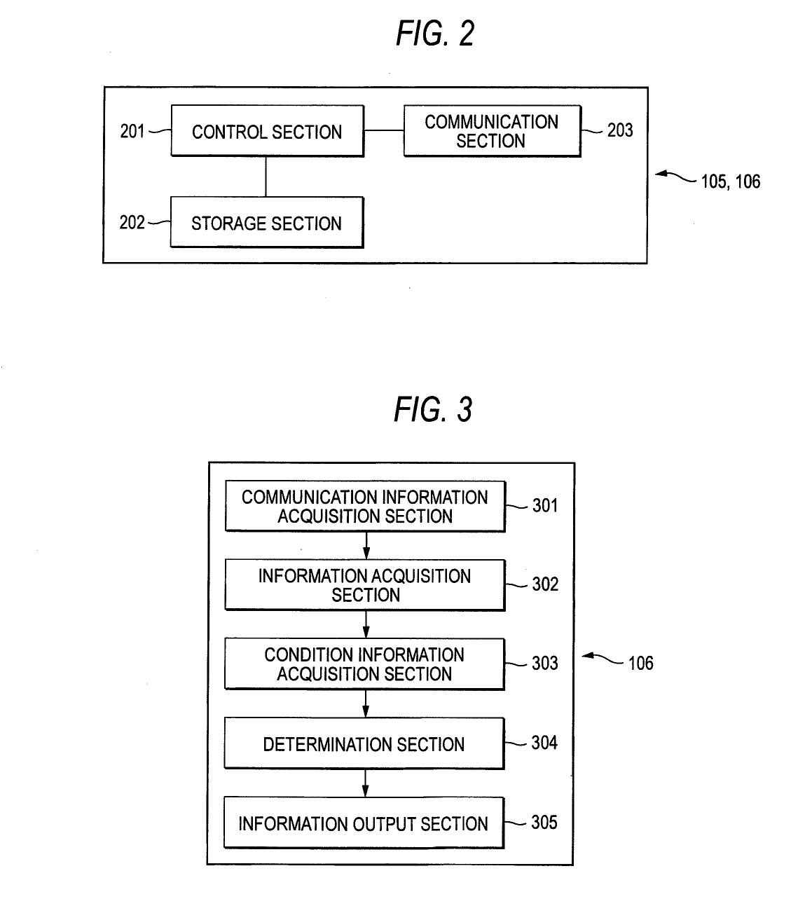

FIG. 2 is a drawing to describe the configuration of the terminal 105, the monitoring server 106 in the exemplary embodiment of the invention. As shown in FIG. 2, each of the terminal 105 and the monitoring server 106 has a control section 201, a storage section 202, and a communication section 203.

The control section 201 is a CPU, etc., and operates in accordance with a program stored in the storage section 202. The program may be provided as it is downloaded through the communication network 104, or may be provided using any of various computer-readable information record media, such as a CD-ROM or a DVD-ROM, for example. The storage section contains memory of RAM, ROM, etc., and stores programs and data to carry out the exemplary embodiment. The communication section 203 communicates with any other terminal, etc., through the network 107.

Each of the terminal 105 and the monitoring server 106 may include an input/output section of a keyboard, a mouse, etc., a display section of a CRT, a liquid crystal display, etc., and a record section of a hard disk, a CD-ROM, etc.

FIG. 3 is a drawing to functionally describe the configuration of the monitoring server. As shown in FIG. 3, the control section 201 and the storage section 202 of the monitoring server 106 includes a communication information acquisition section 301, an information acquisition section 302, a condition information acquisition section 303, a determination section 304, and an information output section 305.

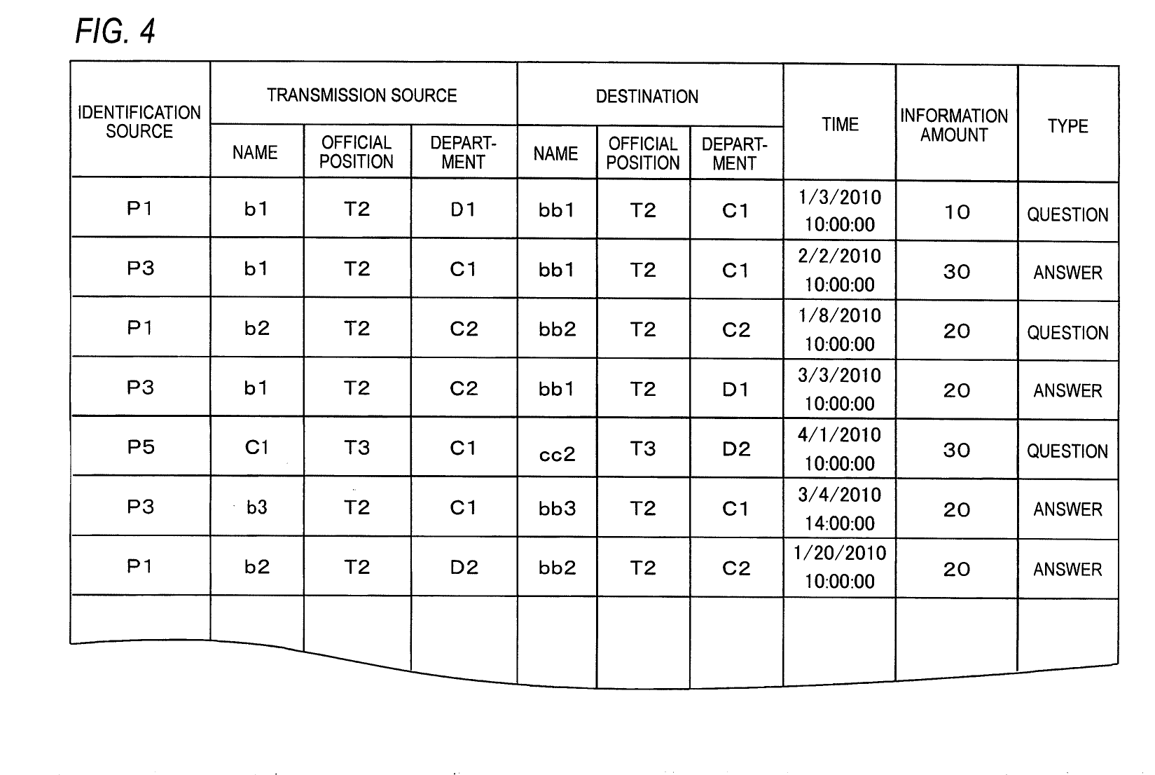

Whenever electronic document data is acquired, the communication information acquisition section 301 acquires and stores communication information contained in the electronic document data in a table format, for example, as shown in FIG. 4.

The communication information is attributes, elements, etc., shown based on transmission of information using the electronic document data; it contains identification information of the project to which the communication information relates, time information concerning the acquisition time of the electronic document data, name information, official position information, and department information of persons of a transmission source and a destination, the information amount of the electronic document data, and information indicating type, etc., of a question, an answer, etc., for example, as shown in FIG. 4.

The information contained in the communication information may contain information different from the above-mentioned information or may be all or a part of the above-mentioned information as long as substantially the same function and effect as the configuration shown in the exemplary embodiment are provided. The format shown in FIG. 4 is an example of the format concerning storage of the communication information and may be a different format as long as substantially the same function and effect as the configuration shown in the exemplary embodiment are provided.

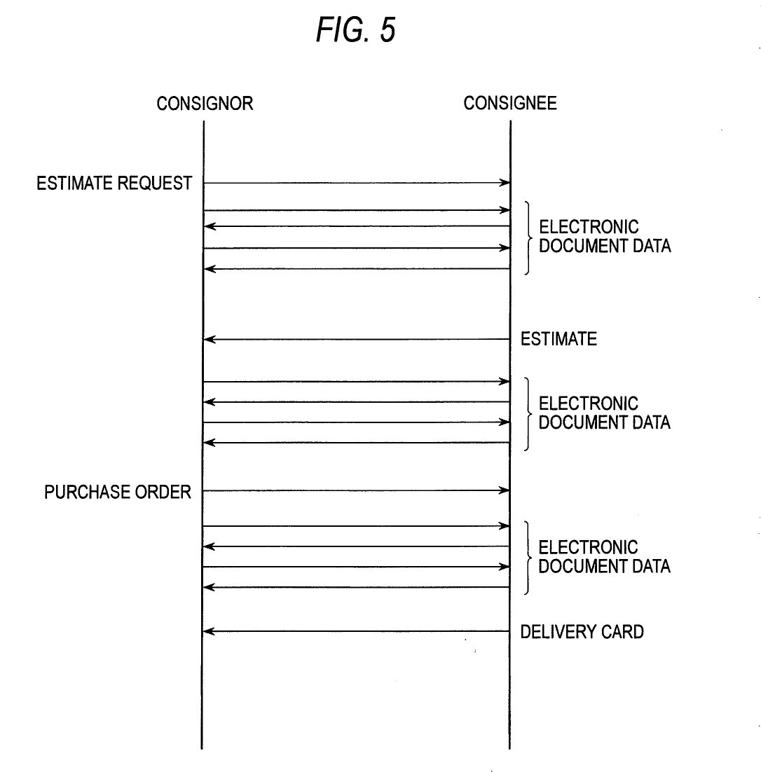

The electronic document data is electronic document data about informal exchange contained in formal document exchange. Specifically, formal document exchange based on a stipulation is executed in the beginning and the last of each project or the beginning and the last of each step of the project between a consignor and a consignee, for example, as shown in FIG. 5. For example, an estimate request, an estimate, a purchase order, a delivery card, or the like is exchanged. In fact, however, an informally exchanged document or data exists in formal document exchange. For example, it is a document or data about a question as to an estimate request and an answer to the question transferred by electronic mail, fax, etc.

That is, the formal document exchange corresponds to exchange of a standard or stipulated document, a document requiring approval of a person in charge of the project or each step of the project, or a document defined as the project, for example. On the other hand, the informal exchange corresponds to a non-standard or unstipulated document or data, a document not approved by a person in charge of the project or each step of the project, or a document not defined on the project, for example.

The electronic document data contains electronic document data read from a paper document through a scanner of the terminal, electronic data of a FAX document transmitted and received by FAX machines, electronic mail transmitted and received by a mail server, an instant message, and any other electronic document, for example.

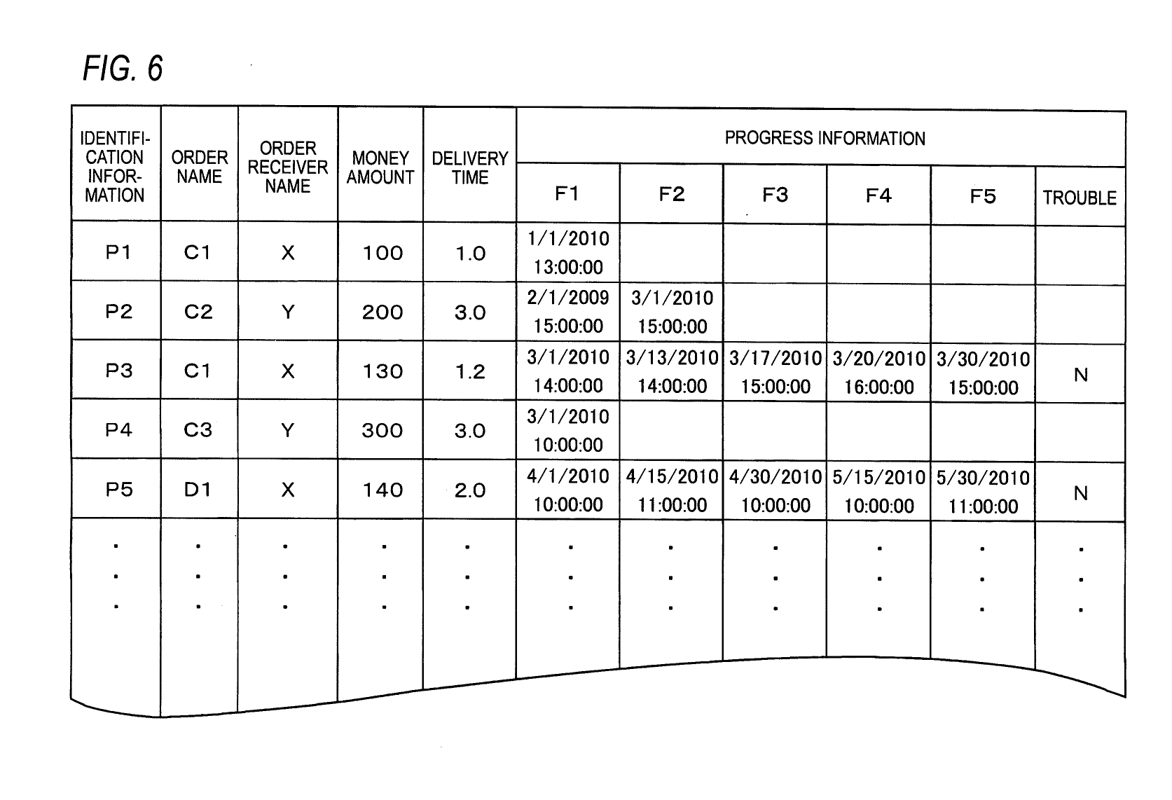

The information acquisition section 302 acquires progress information concerning the progress situation of the corresponding project based on the communication information acquired in the communication information acquisition section 301 as described above. Specifically, for example, the information acquisition section 302 stores management information containing identification information, orderer name information, order receiver name information, money amount information, delivery time information, and progress information for each project, as shown in FIG. 6. Therefore, the information acquisition section 302 references management information having the same identification information as the identification information contained in the acquired communication information, thereby acquiring the progress information of the project corresponding to the acquired communication information.

The management information may be stored in a database connected to the monitoring server 106 and the information acquisition section 302 may acquire the progress information from the database. For example, when the user sends a formal document, for example, an estimate, the management information is input to the information acquisition section 302.

The orderer name information refers to information indicating the name of a person placing an order for the project, and order receiver name information refers to information indicating the name of a company receiving the order. The money amount information refers to information indicating the money amount of a product involved in the project, and the delivery time information refers to information indicating the delivery time of the product involved in the project.

The progress information refers to information the progress situation of the project. Specifically, the progress information is divided into F1 to F5, for example, as shown in FIG. 5; for example, F1 indicates that the progress situation is at the stage from sending of an estimate request to reception of an estimate; F2 indicates that the progress situation is at the stage from reception of the estimate to sending an order; F3 indicates that the progress situation is at the stage from sending of the order to reception of a delivery card; F4 indicates that the progress situation is at the stage from reception of the delivery card to sending of a receiving inspection; and F5 indicates that the progress situation is at the completion stage of the project. For example, as shown in FIG. 6, time information indicating 13 hours on Jan. 1, 2010 is stored in the cell of F1 and if no time information is stored in F2 to F5, it indicates that the progress situation is at the stage of F1 and the stage of F1 was started at 13 hours on Jan. 1, 2010.

For example, when each formal document is transmitted, for example, when an estimate request is sent and when an order is received, the user may register the progress situation in the monitoring server 106 or the formal documents may be read through the scanner, etc., of the terminal and character recognition, etc., may be used, thereby automatically registering the progress situation in the monitoring server 106.

The information contained in the management information may contain information different from the information or may be all or a part of the above-mentioned information as long as substantially the same function and effect as the configuration shown in the exemplary embodiment are provided. The format shown in FIG. 6 is an example of the format concerning storage of the management information and may be a different format as long as substantially the same function and effect as the configuration shown in the exemplary embodiment are provided.

The condition information acquisition section 303 acquires condition information relevant to the progress information, for example. The condition information is, for example, a predetermined condition and is determined for each piece of the progress information and is stored in the condition information acquisition section 303.

The predetermined condition is, for example, that electronic document data from a purchase department is first acquired in the progress situation corresponding to F1, that electronic document data from a quality verification department is last acquired in the progress situation corresponding to F4, that electronic document data concerning a question is first acquired in the progress situation corresponding to F1, etc.

The determination section 304 determines whether or not information corresponding to the communication information matches the condition indicated by the condition information relevant to the progress information. Specifically, assuming the case of the condition that the electronic document data from the purchase department is first acquired in the progress situation corresponding to F1, the determination section 304 determines whether or not it is indicated that the department information of the transmission source of the first acquired communication information is the purchase department from the time information indicated in F1. At this time, the determination section 304 references the time information indicated in F1 and the time information and the department information contained in the communication information. However, to make a determination about different condition information, the determination section 304 references the information contained in the management information and the communication information in response to the condition information, needless to say. For example, for the condition information that the electronic document data concerning a question is first acquired in the progress situation corresponding to F1, the type information is referenced in place of the department information or the like.

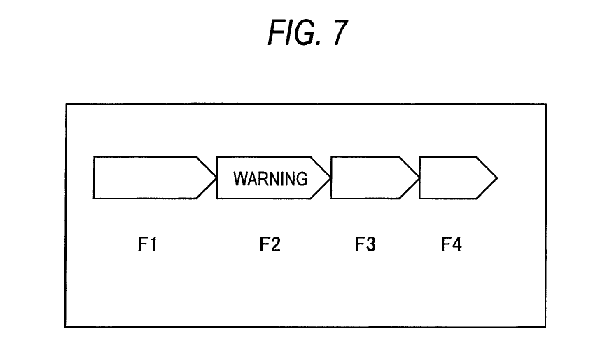

The information output section 305 outputs warning information if the determination section 304 determines that the condition indicated by the condition information is not satisfied. For example, an error message is displayed on a display screen of a preset terminal. In this case, which progress situation the condition indicated by the condition information is not satisfied in may be displayed as shown in FIG. 7. For example, FIG. 7 shows that the user is warned of a high possibility that some problem may occur when the progress information is F2. Although not contained in FIG. 7, the condition may be displayed at the same time. Output of the warning information is not limited to the mode described above and a different mode in which warning mail is transmitted to a preset mail address, etc., may be adopted.

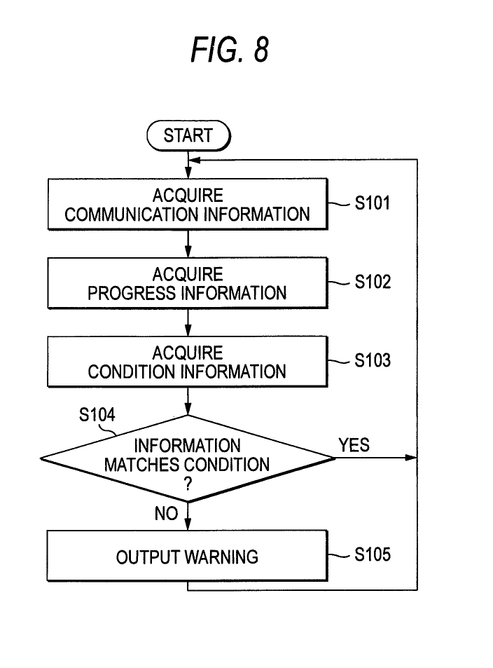

Next, a flow of the monitoring system 100 in the exemplary embodiment will be discussed. As shown in FIG. 8, first, whenever electronic document data is acquired, the communication information acquisition section 301 acquires communication information contained in the electronic document data (S101).

The information acquisition section 302 acquires progress information concerning the progress situation of the corresponding project based on the acquired communication information (S102). Whenever the communication information is acquired, the progress information may be acquired or the project to be monitored may be preset and identification information may be referenced, whereby if the communication information relevant to the project is acquired, the progress information may be acquired.

The condition information acquisition section 303 acquires condition information relevant to the progress information, for example, (S103). As described above, the condition information is, for example, preset by the user, but may be different condition information such as condition information derived from communication information concerning a similar project described later as a second embodiment, etc.

The determination section 304 determines whether or not information corresponding to the communication information matches the condition indicated by the condition information relevant to the progress information (S104). If the determination section 304 determines that the information matches the condition indicated by the condition information, the process returns to S101 and the above-described processing is repeated.

The information output section 305 outputs warning information if the determination section 304 determines that the information does not match the condition indicated by the condition information (S105). Then, the process returns to S101 and the above-described processing is repeated.

According to the exemplary embodiment, the progress situation of the project can be grasped in each step based on the informal electronic document data transmitted between the steps of the project.

In the description of the exemplary embodiment, the user determines whether electronic document data is an informal document or a formal document. However, a determination section for determining whether or not the electronic document data is formal electronic document data may be provided and the communication information acquisition section may acquire the target communication information about the electronic document data determined to be an informal document. In this case, whether or not the data is formal electronic document data is determined by performing character recognition of a character in the electronic document data, for example.

The invention is not limited to the exemplary embodiment described above and the exemplary embodiment may be replaced with substantially the same configuration as shown in the exemplary embodiment described above, the configuration for providing the same function and effect, or the configuration that can accomplish the same object.

### Second Exemplary Embodiment

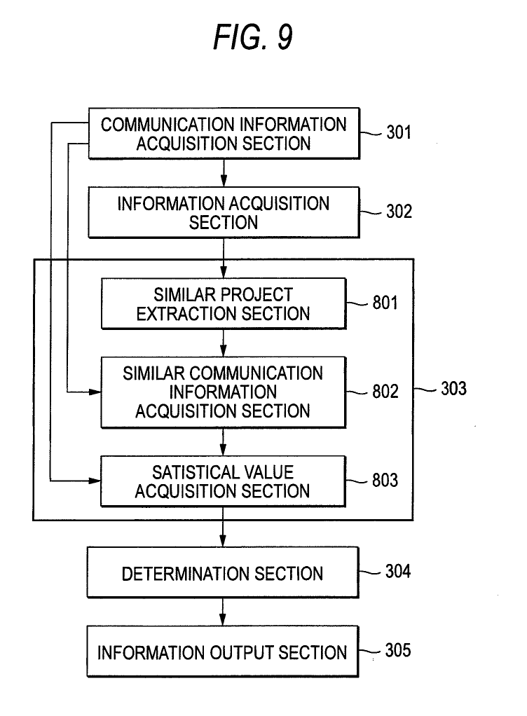

FIG. 9 is a drawing to functionally describe the configuration of a monitoring server 106 in a second exemplary embodiment of the invention. Points similar to those of the first exemplary embodiment will not be discussed again.

An information acquisition section 302 acquires management information concerning the corresponding project based on acquired communication information as with the first embodiment. In the exemplary embodiment, the acquired communication information is, for example, progress information and scale information of the project, but may contain any other information, such as an orderer name, for example, needless to say. The scale information of the project may be represented as money amount information, delivery time information, number-of-steps information, etc.

A condition information acquisition section 303 has a similar project extraction section 801, a similar communication information acquisition section 802, and a statistical value acquisition section 803.

The similar project extraction section 801 extracts identification information of a project (similar project) similar to the project (target project) corresponding to the acquired communication information (target communication information) based on the acquired management information. For example, the identification information and the progress information of a project whose money amount information and delivery time information are the same or similar with no trouble are acquired.

As for the project with no trouble, the user may enter information indicating that no trouble occurred (for example, N in FIG. 6) in management information of the project or when no warning information occurred in a complete project, information indicating that no trouble occurred (for example, N in FIG. 6) may be automatically entered in the management information of the project.

The expression “the money amount information is similar” is used to mean that the money amount indicated by the money amount information is the same or is within a predetermined range. Likewise, the expression “the delivery time information is similar” is used to mean that the delivery time indicated by the delivery time information is the same or is within a predetermined range.

For example, if the range in which the money amount information is less than 50 is a similar range and the range in which the delivery time information is less than 0.5 is a similar range, the project which is within 50 from the money amount information of the target project and is within 0.5 from the delivery time information of the target project is assumed to be a similar project. That is, in the case shown in FIG. 6, if the project of identification information P1 is the target project, the project of identification information P3 is extracted as the similar project. In FIG. 6, the unit of the money information is, for example, dollars and the unit of the delivery time information is months, but any other unit may be adopted.

The similar communication information acquisition section 802 acquires similar communication information based on the identification information and the progress information of the similar project from a communication information acquisition section 301. In the example described above, since P3 is extracted as the similar project, communication information having identification information P3 and time information to time information of progress information F2 later than time information of progress information F1 of management information (second, fourth, and sixth rows in FIG. 4) is acquired.

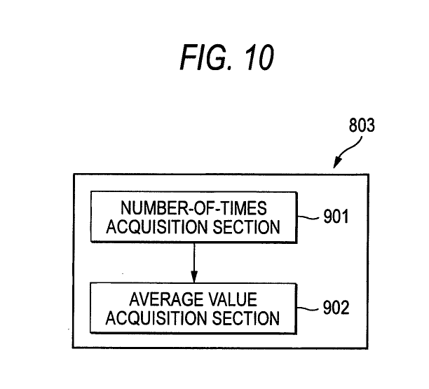

The statistical value acquisition section 803 acquires statistical values corresponding to the target communication information and the similar communication information. In the exemplary embodiment, the statistical value acquisition section 803 has a number-of-times acquisition section 901 and an average value acquisition section 902, for example, as shown in FIG. 10.

The number-of-times acquisition section 901 calculates and acquires the number of pieces of the target communication information and that of the similar communication information every predetermined period relevant to the progress information relevant to the target project. The case where the predetermined time period is 10 days will be discussed using the example described above. As shown in FIG. 6, the stage of F1 of the P1 project starts at Jan. 1, 2010 and thus the number of times of the target communication information from Jan. 1, 2010 to Jan. 10, 2010 is calculated as two. Likewise, the number of pieces of the similar communication information is calculated as three. Although not shown in FIG. 4, likewise, the numbers of pieces of the target communication information and those of the similar communication information from January 11 to January 20 and from January 21 to January 30 are calculated. As the predetermined period, any other time period may be used.

The average value acquisition section 902 acquires an average value of the number of pieces of the similar communication every predetermined period about each similar project. That is, the statistical values described above correspond to the average value of the number of pieces of the target communication information every predetermined time period, of the communication information every predetermined time period and the average value of the number of pieces of the similar communication information.

In the example described above, the number of similar projects is one and thus the average value becomes the number of pieces of the similar communication information every predetermined time period acquired in the number-of-times acquisition section 901. For example, if the number of similar projects is two or more, the number of pieces of the similar communication information every predetermined time period for each similar project is acquired and thus the average value is calculated and is acquired.

The determination section 304 determines whether or not the number of pieces of the target communication information every predetermined time period is within a predetermined range from the average value every predetermined time period.

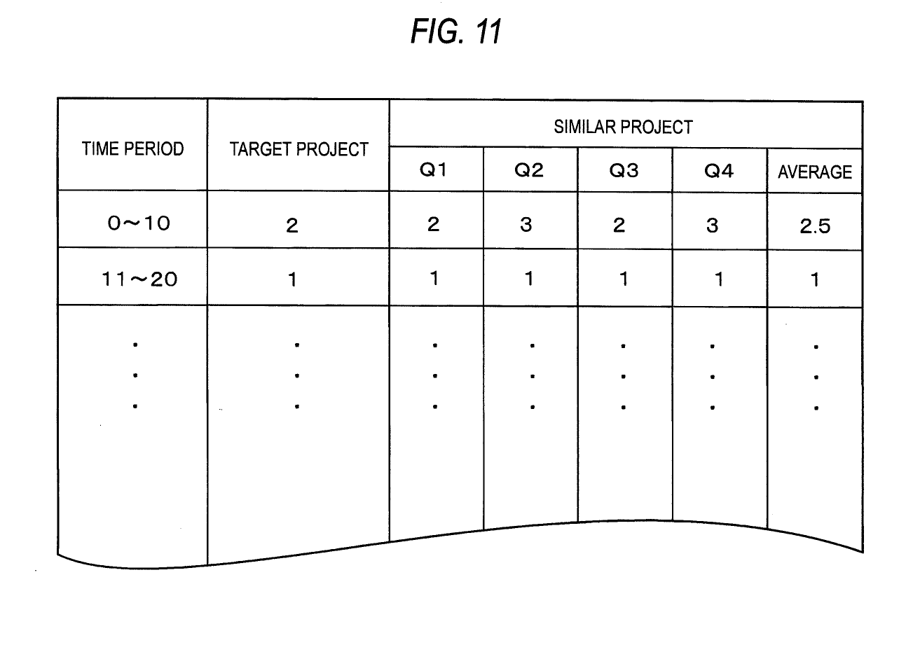

Specifically, for example, as shown in FIG. 11, it is assumed that in the time period 0 to 10 of the target project, the number of pieces of the communication information about the target project is acquired as two and the numbers of pieces of the similar communication information about four similar projects Q1 to Q4 are acquired as two, three, two, and three. In this case, the average value of the numbers of pieces of the similar communication information about the similar projects becomes 2.5. The determination section 304 determines whether or not the number of pieces of the communication information about the target project, two, is within a predetermined range from the average value. For example, assuming that the predetermined range is 1, the number of pieces of the communication information about the target project, two, is within the range of 1 from the average value and thus it is determined that the number is within the predetermined range.

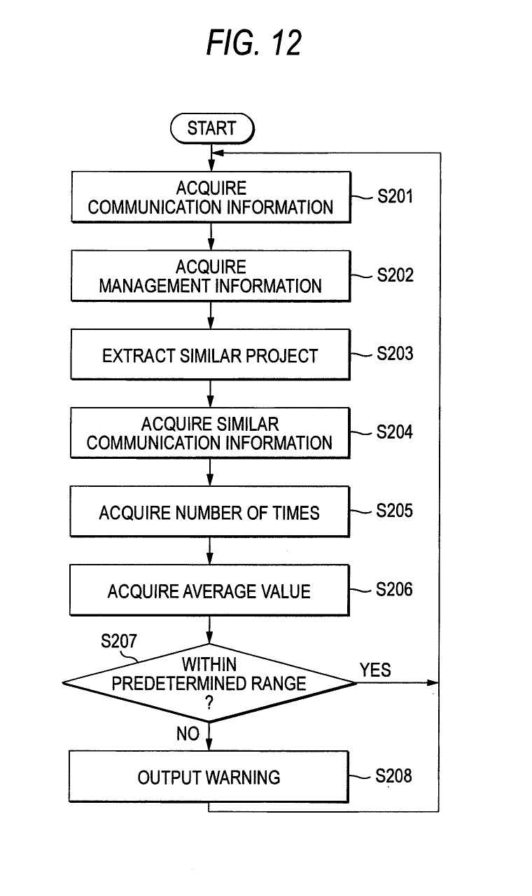

Next, a flow of the monitoring system in the exemplary embodiment will be discussed. As shown in FIG. 12, first, whenever electronic document data is acquired, the communication information acquisition section 301 acquires communication information contained in the electronic document data (S201).

The information acquisition section 302 acquires management information of the corresponding project based on the acquired communication information (S202). Whenever the communication information is acquired, the management information may be acquired or the project to be monitored may be preset and identification information may be referenced, whereby if the communication information relevant to the project is acquired, the management information may be acquired.

The similar project extraction section 801 extracts identification information of a project (similar project) similar to the project (target project) corresponding to the acquired communication information (target communication information) based on the acquired management information (S203).

The similar communication information acquisition section 802 acquires similar communication information based on the identification information and the progress information of the similar project from the communication information acquisition section 301 (S204).

The number-of-times acquisition section 901 calculates and acquires the number of pieces of the target communication information and the number of pieces of the similar communication information every predetermined time period relevant to the progress information relevant to the target project (S205).

The average value acquisition section 902 acquires an average value of the number of pieces of the similar communication every predetermined period about each similar project (S206).

The determination section 304 determines whether or not the number of pieces of the target communication information every predetermined time period is within a predetermined range from the average value every predetermined time period (S207). If the determination section 304 determines that the number is within the predetermined range, the process returns to S201 and the above-described processing is repeated.

If the determination section 304 determines that the number is not within the predetermined range, an information output section 305 outputs warning information (S208). Then, the process returns to S201 and the above-described processing is repeated.

According to the second exemplary embodiment, the progress situation of the project can be grasped in each step based on the informal electronic document data transmitted between the steps of the project. Specifically, if the project progresses in a different tendency from the past identical or similar project about the number of exchange times of electronic document data, warning information is output.

The invention is not limited to the exemplary embodiment described above and the exemplary embodiment may be replaced with substantially the same configuration as shown in the exemplary embodiment described above, the configuration for providing the same function and effect, or the configuration that can accomplish the same object.

### Third Exemplary Embodiment

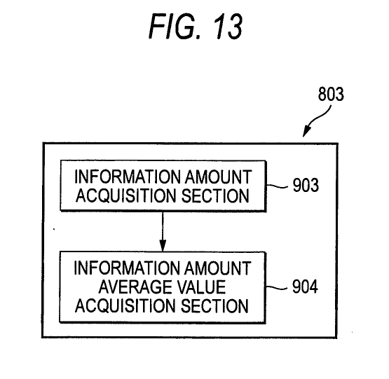

FIG. 13 is a drawing to functionally describe the configuration of a statistical value acquisition section in a third exemplary embodiment of the invention. In the exemplary embodiment, the configuration of the statistical value acquisition section differs from that of the second exemplary embodiment. Other points are similar to those of the second exemplary embodiment and will not be discussed again.

As shown in FIG. 13, a statistical value acquisition section 803 has an information amount acquisition section 903 and an information amount average value acquisition section 904.

The information amount acquisition section 903 acquires sums of information amounts contained in target communication information and similar communication information every predetermined time period. The information amount is information indicating the data amount of electronic document data such as the number of characters or the number of pages contained in the electronic document data.

The information amount average value acquisition section 904 acquires the average value of the sums of the similar communication information amounts every predetermined time period about each similar project. That is, the statistical values described above correspond to the average value of the sums of the information amounts of the target communication information every predetermined time period, of the communication information every predetermined time period and the average value of the sums of the similar communication information about each similar project.

In the example described above, since the number of similar projects is one, the average value becomes the sum of the information amounts of the similar communication information every predetermined time acquired in the information amount acquisition section 903. For example, if the number of similar projects is two or more, the number of pieces of the similar communication information every predetermined time period for each similar project and thus the average value is calculated and is acquired.

A determination section 304 determines whether or not the sum of the information amounts of the target communication information every predetermined time period is within a predetermined range from the average value of the sums of the numbers of pieces of the similar communication information about each similar project.

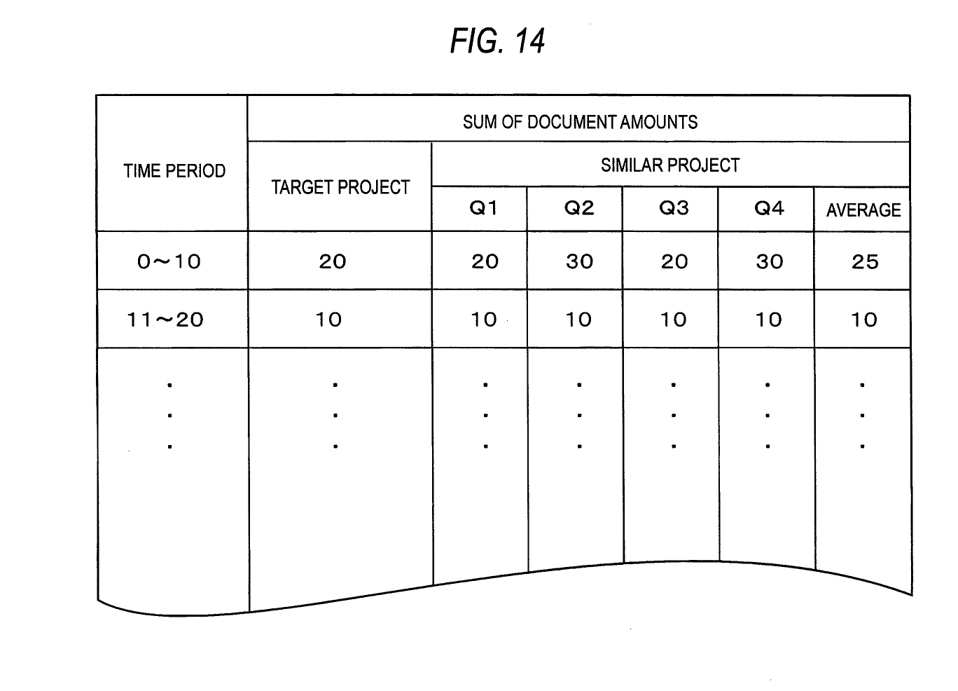

Specifically, for example, as shown in FIG. 14, it is assumed that the sum of the information amounts of the communication information about the target project is acquired as 20 and the sums of the similar communication information amounts about four similar projects Q1 to Q4 are acquired as 20, 30, 20, and 30 in the target project time period 0 to 10. In this case, the average value of the sums of the information amounts of the similar communication information about the similar projected becomes 25. The determination section 304 determines whether or not the sum of the communication information amounts about the target project is within a predetermined range from the average value. For example, assuming that the predetermined range is 10, the sum of the information amounts of the communication information about the target project, 20, is within the range of 10 from the average value and thus it is determined that the sum is within the predetermined range. As the predetermined time period, any other time period may be used.

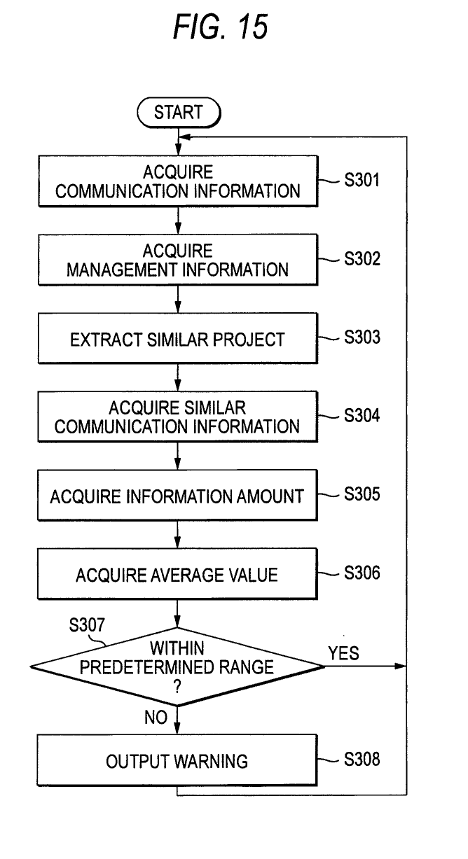

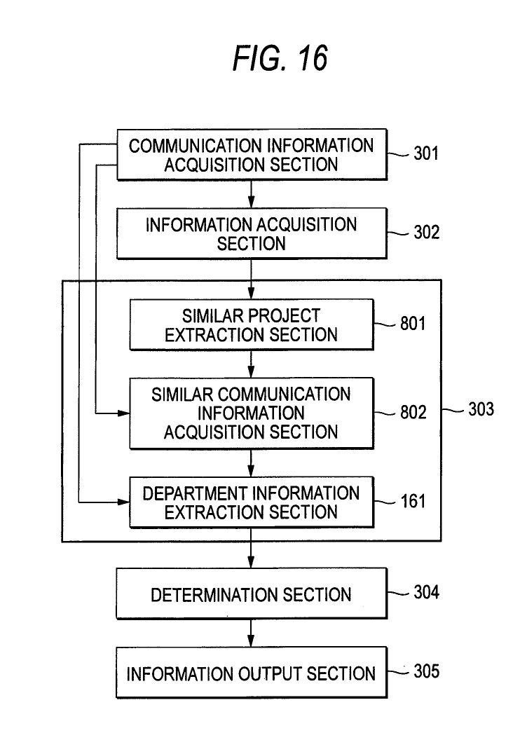

Next, a flow of a monitoring system 100 in the exemplary embodiment will be discussed. As shown in FIG. 15, first, whenever electronic document data is acquired, a communication information acquisition section 301 acquires communication information contained in the electronic document data (S301).

An information acquisition section 302 acquires management information of the corresponding project based on the acquired communication information (S302). Whenever the communication information is acquired, the management information may be acquired or the project to be monitored may be preset and identification information may be referenced, whereby if the communication information relevant to the project is acquired, the management information may be acquired.

A similar project extraction section 801 extracts identification information of a project (similar project) similar to the project (target project) corresponding to the acquired communication information (target communication information) based on the acquired management information (S303).

A similar communication information acquisition section 802 acquires similar communication information based on the identification information and the progress information of the similar project from the communication information acquisition section 301 (S304).

The information amount acquisition section 903 acquires sums of information amounts contained in the target communication information and the similar communication information every predetermined time period (S305).

The information amount average value acquisition section 904 acquires the average value of the sums of the similar communication information amounts every predetermined time period about each similar project (S306).

The determination section 304 determines whether or not the sum of the information amounts of the communication information every determined period is within a predetermined range from the average value of the sums of the information amounts of the similar communication about each similar project (S307). If the determination section 304 determines that the sum is within the predetermined range, the process returns to S301 and the above-described processing is repeated.

If the determination section 304 determines that the sum is not within the predetermined range, an information output section 305 outputs warning information (S308). Then, the process returns to S301 and the above-described processing is repeated.

According to the third exemplary embodiment, the progress situation of the project can be grasped in each step based on the informal electronic document data transmitted between the steps of the project. Specifically, if the project progresses in a different tendency from the past identical or similar project about the data amount contained in the electronic document data, warning information is output.

The invention is not limited to the exemplary embodiment described above and the exemplary embodiment may be replaced with substantially the same configuration as shown in the exemplary embodiment described above, the configuration for providing the same function and effect, or the configuration that can accomplish the same object.

### Fourth Exemplary Embodiment

FIG. 13 is a drawing to functionally describe the configuration of a monitoring server in a fourth exemplary embodiment of the invention. Points similar to those of the second exemplary embodiment will not be discussed again.

A condition information acquisition section 303 has a similar project extraction section 801, a similar communication information acquisition section 802, and a department information extraction section 161.

The similar project extraction section 801 extracts identification information of a project (similar project) similar to the project (target project) corresponding to the acquired communication information (target communication information) based on the acquired management information like the similar project extraction section 801 of the second exemplary embodiment. Specifically, for example, the identification information and the progress information of a project whose money amount and delivery time are the same as or similar to those of the target project are acquired.

The similar communication information acquisition section 802 acquires similar communication information, for example, based on the identification information and the progress information of the similar project from a communication information acquisition section 301 like the similar communication information acquisition section 802 of the second exemplary embodiment. Specifically, for example, referring to FIG. 4, when the project of the P1 identification information is the target project and P3 is extracted as the similar project, communication information having identification information P3 and time information to time information of progress information F2 later than time information of progress information F1 of management information (second, fourth, and sixth rows in FIG. 4) is acquired.

The department information extraction section 161 acquires department information contained in the acquired target communication information and the acquired similar communication information. In the example described above, as for the transmission source, D1, C2, and D2 are acquired as the department information contained in the target communication information. Likewise, C1 and C2 are acquired as the department information contained in the similar communication information. Likewise, as for the destination, department information is also acquired. The department information may be acquired for each transmission source and destination or may be acquired at the same time.

The determination section 304 determines whether or not the department information contained in the target communication information differs from the department information contained in the similar communication information. In the example described above, the department information in the target communication information contains department information D1 and D2 not contained in the similar communication information and thus the determination section 304 determines that the department information contained in the target communication information differs from the department information contained in the similar communication information. If the department information is acquired for each transmission source and destination, the determination section 304 determines whether or not the department information differs from the department information contained in the similar communication information for each transmission source and destination.

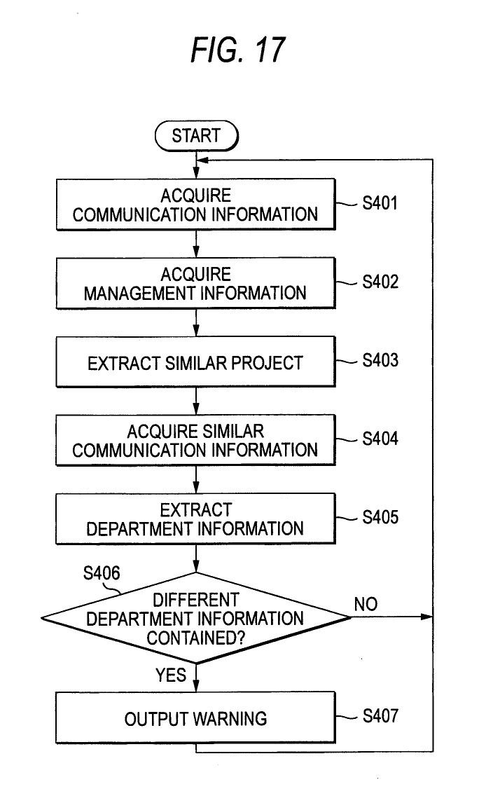

Next, a flow of a monitoring system 100 in the exemplary embodiment will be discussed. As shown in FIG. 17, first, whenever electronic document data is acquired, the communication information acquisition section 301 acquires communication information contained in the electronic document data. (S401).

An information acquisition section 302 acquires management information of the corresponding project based on the acquired communication information (S402). Whenever the communication information is acquired, the management information may be acquired or the project to be monitored may be preset and identification information may be referenced, whereby if the communication information relevant to the project is acquired, the management information may be acquired.

The similar project extraction section 801 extracts identification information of a project (similar project) similar to the project (target project) corresponding to the acquired communication information (target communication information) based on the acquired management information (S403).

The similar communication information acquisition section 802 acquires similar communication information based on the identification information and the progress information of the similar project from the communication information acquisition section 301 (S404).

The department information extraction section 161 acquires department information contained in the acquired target communication information and the acquired similar communication information (S405).

The determination section 304 determines whether or not the department information contained in the target communication information differs from the department information contained in the similar communication information (S406). If the determination section 304 determines that the department information does not differ, the process returns to S401 and the above-described processing is repeated.

If the determination section 304 determines that the department information differs, an information output section 305 outputs warning information (S407). Then, the process returns to S401 and the above-described processing is repeated.

According to the fourth exemplary embodiment, the progress situation of the project can be grasped in each step based on the non-stipulated electronic document data transmitted between the steps of the project. Specifically, if the project progresses in a different tendency from the past identical or similar project about the department information contained in the electronic document data, warning information is output. The invention is not limited to the exemplary embodiment described above and the exemplary embodiment may be replaced with substantially the same configuration as shown in the exemplary embodiment described above, the configuration for providing the same function and effect, or the configuration that can accomplish the same object.

### Fifth Exemplary Embodiment

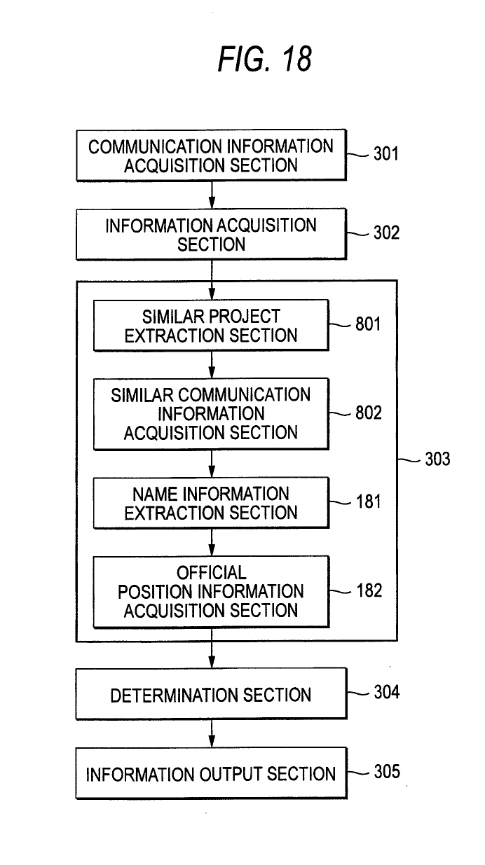

FIG. 18 is a drawing to functionally describe the configuration of a monitoring server in a fifth exemplary embodiment of the invention. Points similar to those of the second exemplary embodiment will not be discussed again.

A condition information acquisition section 303 has a similar project extraction section 801, a similar communication information acquisition section 802, a name information extraction section 181, and an official position information acquisition section 182.

The similar project extraction section 801 extracts identification information of a project (similar project) similar to the project (target project) corresponding to the acquired communication information (target communication information) based on the acquired management information like the similar project extraction section 801 of the second exemplary embodiment. Specifically, for example, the identification information and the progress information of a project whose money amount and delivery time are the same as or similar to those of the target project are acquired.

The similar communication information acquisition section 802 acquires similar communication information, for example, based on the identification information and the progress information of the similar project from a communication information acquisition section 301 like the similar communication information acquisition section 802 of the fourth exemplary embodiment.

The name information extraction section 181 extracts name information contained in the target communication information and the similar communication information. For example, referring to FIG. 4, when the project of the P1 identification information is the target project and P3 is extracted as the similar project, b1 and b2 are acquired as the name information contained in the target communication information and b1 and b3 are acquired as the name information contained in the similar communication information.

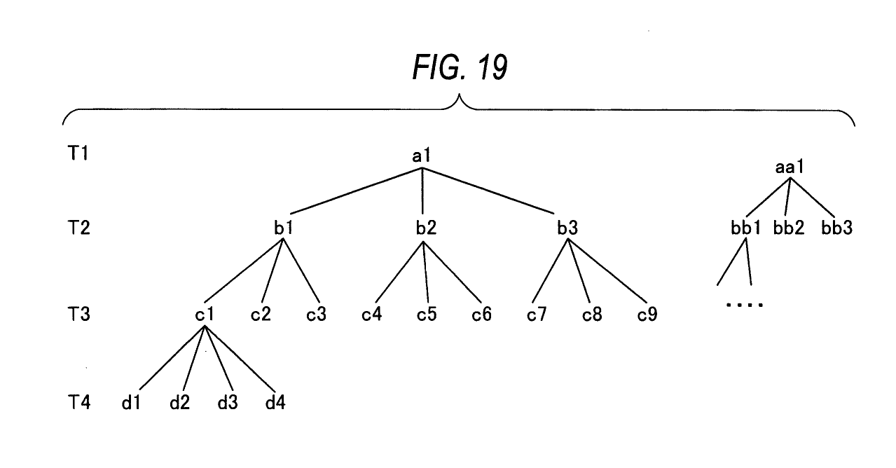

The official position information acquisition section 182 acquires official position information of each piece of the name information based on the name information contained in the target communication information and the similar communication information. Specifically, for example, as shown in FIG. 19, the official position information acquisition section 182 stores the name information in a tree structure of names in the descending order of official positions and acquires each piece of the official position information in response to each acquired piece of the name information. In the example described above, T2 is acquired as the official position information of b1, b2, and b3. The official position information shown in FIG. 19 may be stored, for example, in an external database, etc., of a monitoring server 106 and the official position information acquisition section 182 may acquire the official position information from the database. As the official position information, official position information contained in the target or similar communication information may be acquired. Further, the official position information contained in the target or similar communication information may be acquired and may be updated.

A determination section 304 determines whether or not the official position information corresponding to the target communication information differs from the official position information corresponding to the similar communication information, namely, whether or not a superior or a subordinate is contained. In the example described above, the official position information is the same T2 and thus it is determined that the official position information corresponding to the target communication information is the same as the official position information corresponding to the similar communication information. In the exemplary embodiment, determination is made based on whether or not the official position information is the same without differentiating between a superior and a subordinate. However, determination may be made by differentiating between the case where a superior is contained and the case where a subordinate is contained by referencing the tree structure shown in FIG. 19 and, for example, warning information may be output only if a superior is contained. In FIG. 19, for example, the tree structure about two companies or departments is shown, but a tree structure may be provided for each company or for each department of each company.

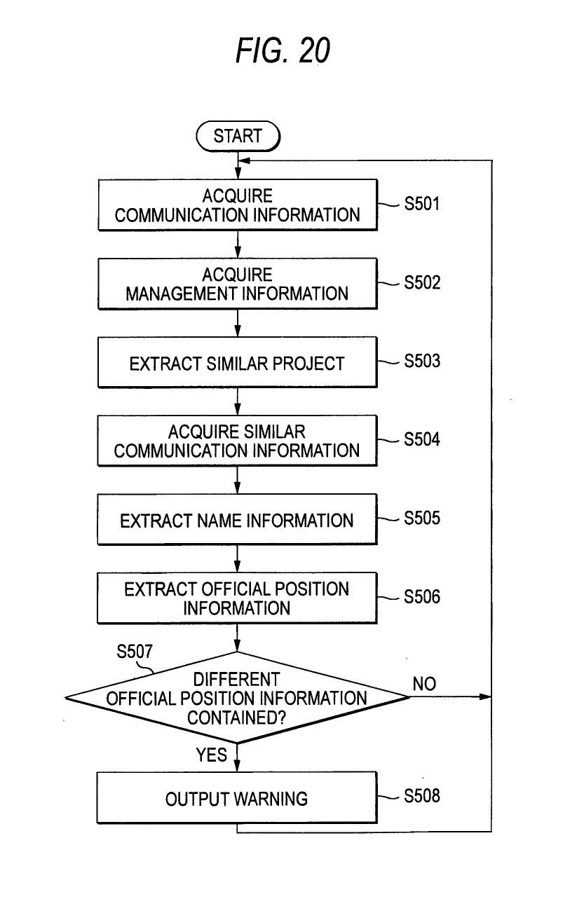

Next, a flow of a monitoring system 100 in the exemplary embodiment will be discussed. As shown in FIG. 20, first, whenever electronic document data is acquired, the communication information acquisition section 301 acquires communication information contained in the electronic document data (S501).

An information acquisition section 302 acquires management information of the corresponding project based on the acquired communication information (S502). Whenever the communication information is acquired, the management information may be acquired or the project to be monitored may be preset and identification information may be referenced, whereby if the communication information relevant to the project is acquired, the management information may be acquired.

The similar project extraction section 801 extracts identification information of a project (similar project) similar to the project (target project) corresponding to the acquired communication information (target communication information) based on the acquired management information (S503).

The similar communication information acquisition section 802 acquires similar communication information based on the identification information and the progress information of the similar project from the communication information acquisition section 301 (S504).

The name information extraction section 181 extracts the name information contained in the target communication information and the similar communication information (S505).

The official position information acquisition section 182 acquires official position information of the name information based on the name information contained in the target communication information and the similar communication information (S506).

The determination section 304 determines whether or not the official position information corresponding to the target communication information differs from the official position information corresponding to the similar communication information, namely, whether or not a superior or a subordinate is contained (S507). If the determination section 304 determines that the official position information does not differ, the process returns to S501 and the above-described processing is repeated.

If the determination section 304 determines that the official position information differs, an information output section 305 outputs warning information (S508). Then, the process returns to S501 and the above-described processing is repeated.

According to the fifth exemplary embodiment, the progress situation of the project can be grasped in each step based on the informal electronic document data transmitted between the steps of the project. Specifically, if the project progresses in a different tendency from the past identical or similar project about the official position information acquired based on the electronic document data, warning information is output.

The invention is not limited to the exemplary embodiment described above and the exemplary embodiment may be replaced with substantially the same configuration as shown in the exemplary embodiment described above, the configuration for providing the same function and effect, or the configuration that can accomplish the same object.

### Sixth Exemplary Embodiment

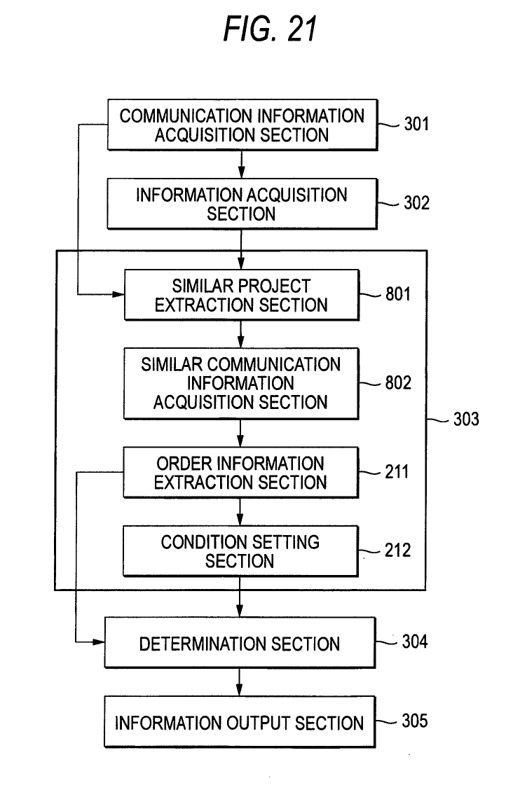

FIG. 21 is a drawing to functionally describe the configuration of a monitoring server in a sixth exemplary embodiment of the invention. Points similar to those of the second exemplary embodiment will not be discussed again.

A condition information acquisition section 303 has a similar project extraction section 801, a similar communication information acquisition section 802, an order information acquisition section 211, and a condition setting section 212.

The similar project extraction section 801 extracts identification information of a project (similar project) similar to the project (target project) corresponding to the acquired communication information (target communication information) based on the acquired management information like the similar project extraction section 801 of the second exemplary embodiment.

The similar communication information acquisition section 802 acquires similar communication information, for example, based on the identification information and the progress information of the similar project from a communication information acquisition section 301 like the similar communication information acquisition section 802 of the second exemplary embodiment.

The order information acquisition section 211 acquires the order concerning transmission and reception of electronic document data, namely, information as to data is transmitted from which department to which department (order information) based on transmission source, destination information contained in the target communication information and the similar communication information.

For example, referring to FIG. 4, when the project of the P1 identification information is the target project and P3 is extracted as the similar project, D1, C2, and D2 are acquired as the order information about the target communication information and C1, C2, and C1 are acquired as the order information about the similar communication information. In the example, only the order information about the transmission source is described, but order information about the destination or order information about a combination of the transmission source and the destination may be adopted.

The condition setting section 212 sets the order information contained in a predetermined percentage in the order information corresponding to a plurality of pieces of similar communication information as condition information. For example, order information such that the transmission sources D1 and C2 are contained in 90% about the time period about progress information F1 about a large number of pieces of similar communication information is set as the condition information. The predetermined percentage is set arbitrarily by the user and is not limited to 90%.

A determination section 304 determines whether or not the order information corresponding to the target communication information matches a setup condition.

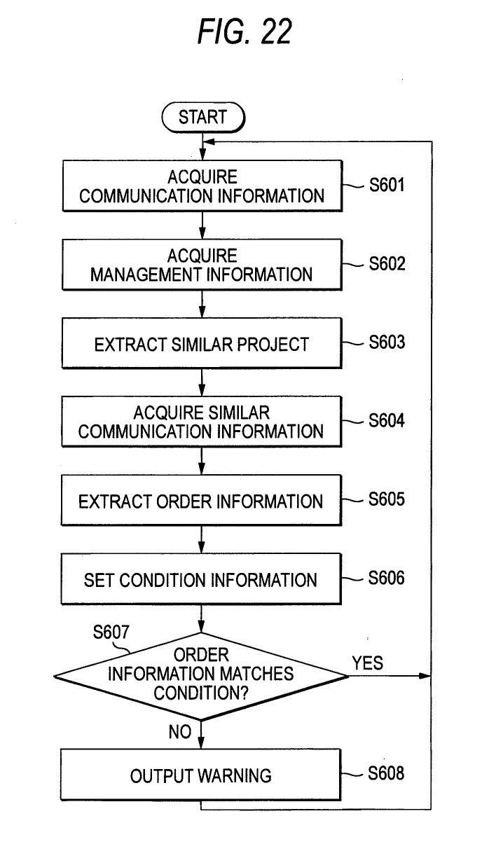

Next, a flow of a monitoring system 100 in the exemplary embodiment will be discussed. As shown in FIG. 22, first, whenever electronic document data is acquired, the communication information acquisition section 301 acquires communication information contained in the electronic document data (S601).

An information acquisition section 302 acquires management information of the corresponding project based on the acquired communication information (S602). Whenever the communication information is acquired, the management information may be acquired or the project to be monitored may be preset and identification information may be referenced, whereby if the communication information relevant to the project is acquired, the management information may be acquired.

The similar project extraction section 801 extracts identification information of a project (similar project) similar to the project (target project) corresponding to the acquired communication information (target communication information) based on the acquired management information (S603).

The similar communication information acquisition section 802 acquires similar communication information based on the identification information and the progress information of the similar project from the communication information acquisition section 301 (S604).

The order information acquisition section 211 acquires the order concerning transmission and reception of electronic document data, namely, information as to data is transmitted from which department to which department (order information) based on transmission source, destination information contained in the target communication information and the similar communication information (S605).

The condition setting section 212 sets the order information contained in a predetermined percentage in the order information corresponding to a plurality of pieces of similar communication information as the condition information (S606).

The determination section 304 determines whether or not the order information corresponding to the target communication information matches a setup condition (S607). If the determination section 304 determines that the order information matches the condition, the process returns to S601 and the above-described processing is repeated.

If the determination section 304 determines that the order information does not match the condition, an information output section 305 outputs warning information (S608). Then, the process returns to S601 and the above-described processing is repeated.

According to the sixth exemplary embodiment, the progress situation of the project can be grasped in each step based on the informal electronic document data transmitted between the steps of the project. Specifically, if the project progresses in a different tendency from the past identical or similar project about the order information acquired based on the electronic document data, warning information is output.

The invention is not limited to the first to sixth exemplary embodiments described above and each of the exemplary embodiments may be replaced with substantially the same configuration as shown in each of the exemplary embodiments described above, the configuration for providing the same function and effect, or the configuration that can accomplish the same object. The first to sixth exemplary embodiments described above may be used in combination unless a contradiction occurs.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

What is claimed is:

1. A monitoring system comprising:
a communication information acquisition unit that acquires communication information contained in each piece of electronic document data and containing identification information about a project and time information corresponding to acquisition time of each piece of electronic document data as target communication information;
an information acquisition unit that acquires progress information concerning a progress situation about the project based on the target communication information;
a condition information acquisition unit that acquires condition information relevant to the acquired progress information;
a determination unit that determines whether or not information corresponding to the target communication information matches a condition indicated by the condition information; and
a determination information output unit that outputs determination information based on the determination result of the determination unit.

2. The monitoring system according to claim 1, wherein the information acquisition unit further acquires management information containing project scale information concerning the project, and wherein
the condition information acquisition unit further includes:
a similar communication information acquisition unit that acquires similar communication information of the communication information about one or more projects similar to that project based on the acquired management information; and
a statistical value acquisition unit that acquires statistical values corresponding to the target communication information and the similar communication information as information corresponding to the target communication information and the condition information.

3. The monitoring system according to claim 2 further comprising:
a number-of-times acquisition unit that acquires the numbers of pieces of the similar communication information and the target communication information every predetermined time period based on the time information contained in the similar communication information and the target communication information; and
an average value acquisition unit that acquires average values of the numbers of pieces of the target communication information and the similar communication information,
wherein the statistical values are average values of the numbers.

4. The monitoring system according to claim 2 further comprising:
an information amount acquisition unit that acquires sums of information amounts of the similar communication information and the target communication information every predetermined time period based on the time information contained in the similar communication information and the target communication information; and
an information amount average value acquisition unit that acquires average values of the sums of the information amounts of the target communication information and the similar communication information,
wherein the statistical values are average values of the sums of the information amounts.

5. The monitoring system according to claim 1, wherein the information acquisition unit further acquires management information containing project scale information concerning the project,
wherein the condition information acquisition unit has unit that acquires similar communication information of the communication information about one or more projects similar to that project based on the acquired management information, and
the determination unit determines department information contained in the target communication information and department information contained in the similar communication information as information corresponding to the target communication information and the condition information.

6. The monitoring system according to claim 1, wherein the information acquisition unit further acquires management information containing project scale information concerning the project,
wherein the condition information acquisition unit further includes:
a similar communication information acquisition unit that acquires similar communication information of the communication information about one or more projects similar to that project based on the acquired management information;
a name information extraction unit that extracts name information contained in the similar communication information and the target communication information; and
an official position information acquisition unit that acquires official position information stored in association with the name information based on the name information, and
the determination unit determines the official position information contained in the target communication information and the official position information contained in the similar communication information as information corresponding to the target communication information and the condition information.

7. The monitoring system according to claim 1, wherein the information acquisition unit further acquires orderer information indicating an orderer of the project.

8. The monitoring system according to claim 1, wherein the information acquisition information contains order receiver information indicating an order receiver of the project.

9. The monitoring system according to claim 1, wherein the communication information contains name information indicating a name of a person of a transmission source and/or destination of the electronic document data.

10. The monitoring system according to claim 1, wherein the communication information includes official position information indicating an official position of a name of a person of a transmission source and/or destination of the electronic document data.

11. The monitoring system according to claim 1, wherein the communication information includes department information indicating a department to which a person of a transmission source and/or destination of the electronic document data belongs.

12. The monitoring system according to claim 1, wherein the communication information includes information indicating an amount of information contained in the electronic document data.

13. The monitoring system according to claim 1, wherein the communication information includes type information indicating the type of electronic document data.

14. The monitoring system according to claim 1 further comprising a determination unit that determines whether or not the electronic document data is formal electronic document data,
wherein the communication information acquisition unit acquires the target communication information about the electronic document data determined to be informal electronic document data.

15. A computer readable medium storing a program causing a computer to execute a process for monitoring system, the process comprising:
acquiring communication information contained in each piece of electronic document data and containing identification information about a project and time information corresponding to acquisition time of each piece of electronic document data as target communication information;
acquiring progress information concerning a progress situation about the project based on the target communication information;
acquiring condition information relevant to the acquired progress information;
determining whether or not information corresponding to the target communication information matches a condition indicated by the condition information; and
outputting determination information based on the determination result in the determination step.

16. A monitoring method comprising:
acquiring communication information contained in each piece of electronic document data and containing identification information about a project and time information corresponding to acquisition time of each piece of electronic document data as target communication information;
acquiring progress information concerning a progress situation about the project based on the target communication information;
acquiring condition information relevant to the acquired progress information;
determining whether or not information corresponding to the target communication information matches a condition indicated by the condition information; and
outputting determination information based on the determination result in the determination step.
